(19) United States
(12) Patent Application Publication
(10) Pub. No.: US 2007/0213911 A1
(43) Pub. Date: Sep. 13, 2007

(54) TRAILBRAKING

(75) Inventors: Roger Trombley, Ann Arbor, MI (US); Jerry Engelman, Plymouth, MI (US)

Correspondence Address: Dickinson Wright PLLC, 38525 Woodward Avenue, Suite 2000, Bloomfield Hills, MI, 48304, US

(73) Assignee: FORD GLOBAL TECHNOLOGIES, LLC, Dearborn, MI (US)

(21) Appl. No.: 11/308,169

(22) Filed: Mar. 9, 2006

(51) Int. Cl. G06G 7/76

(52) U.S. Cl. 701/70

(57) ABSTRACT

A system for trailbraking includes a velocity sensor providing a velocity output signal, a second sensor providing a second output signal and a trailbraking controller for receiving the velocity output signal and the second output signal. The trailbraking controller will provide an output control signal conditioned by the velocity output signal and the second output signal when indicative of an emergency avoidance maneuver. A method for trailbraking is provided.

### TECHNICAL FIELD

The present invention relates generally to a system for increasing vehicle responsiveness, and more particularly, to a method and system for increasing vehicle responsiveness by braking.

### BACKGROUND OF THE INVENTION

Significant improvement and development in the area of vehicle passive systems has occurred over the recent decades. Passive systems, as its name implies, are devices designed to mitigate the effects of an accident once it has already occurred. Generally, they are not designed to help avoid accidents, but instead they act to reduce the severity of the accidents.

More recently, vehicular improvements have been made in the area of active systems. Active systems may employ countermeasures to help avoid an accident. Active systems already in production include, Anti-Lock Brakes (ABS), Traction Control System (TCS), and Integrated Vehicle Dynamics (IVD). These devices actively aid a situationally independent operator in avoiding accidents before they occur by helping the vehicle to maintain stability in situations where it would have otherwise lost it.

ABS works to allow the driver to maintain steer-ability while maintaining maximum braking. Also, ABS works by pulsing the brakes just at the point before wheel lockup. TCS is an extension of the ABS system and is designed to prevent the wheels from spinning while accelerating on a surface with different coefficients of friction. TCS system works by applying a slight amount of braking to a wheel that has started to slip, preventing the wheel from spinning. IVD uses brakes at individual wheel corners to control the yaw moment of a vehicle. If the yaw moment exceeds a certain threshold, differential brake pressure is employed at each of the individual wheel corners that has the effect of stabilizing the vehicle. However, these active systems are limited to improving some aspects of vehicle stability. For instance, the above mentioned active systems are limited in their response for the example shown in FIG. 1 where a subject vehicle A has surpassed the impact distance, otherwise required for stopping, before impacting a subject vehicle B.

FIG. 1 shows a diagram 20 of a clipping accident. Vehicle A attempts to pass vehicle B, but does not have enough space to do so nor is there sufficient time or distance to bring Vehicle A to a stop, therefore vehicle A clips the rear end of vehicle B. If vehicle A in this example was even just a little more responsive, then this clipping example incident may have been avoided.

While passive and active systems are important, it would be desirous to enhance vehicle performance in the furtherance of loss mitigation by providing a system that may both lessens the vehicular speed during an attempted crash avoidance maneuver and improves the would-be impact distance during an avoidance maneuver. It would also be desirous to provide a system that may, in some instances, result in an avoidance maneuver.

Accordingly, there is a need for an active system that will give the driver a better chance of driving clear of an accident by increasing the responsiveness of the vehicle.

### SUMMARY OF THE INVENTION

Trailbraking, an active system, is provided. Trailbraking increases the responsiveness of a vehicle and may be used during an emergency avoidance maneuver to decrease the longitudinal distance traveled during the maneuver. Trailbraking provides increased responsiveness by applying a small amount of braking that causes weight to transfer to the front of the vehicle. This in turns allows the front tires to handle higher lateral forces, which allow the vehicle to perform a turn quicker.

A system for trailbraking includes a velocity sensor providing a velocity output signal, a second sensor providing a second output signal and a trailbraking controller for receiving the velocity output signal and the second output signal. The trailbraking controller will provide an output control signal conditioned by the velocity output signal and the second output signal when indicative of an emergency avoidance maneuver.

Also, a method for trailbraking is provided.

In one aspect, trailbraking works to influence the driving dynamics of the vehicle by introducing braking.

In another aspect, trailbraking works within the tractive limits of the tire and relies on weight transfer to the front wheels to increase the tractive force on the tires while the braking is applied.

The present invention has advantages by providing a trailbraking system. The present invention itself, together with further attendant advantages, will be best understood by reference to the following detailed description and taken in conjunction with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention.

FIG. 1 is a diagram showing a clipping accident.

FIG. 2 is a graph showing distance saved as a function of vehicle speed.

FIG. 3 shows a vehicle coordinate system.

FIG. 4 shows a free body diagram of vehicle forces.

FIG. 5 shows a tire model basic curve.

FIG. 6 shows a coordinate for tire slip angle properties.

FIG. 7 shows a sample plot of lateral force versus slip angle for a 195/65 R15 tire that was modeled using the Magic Formula.

FIG. 8 shows factors affecting longitudinal slip of a tire.

FIG. 9 shows a sample plot of longitudinal force versus slip angle for a 195/65 R15 tire that was modeled using the Magic Formula.

FIG. 10 shows a diagram of the friction circle.

FIG. 11 shows a diagram representing contact patch for vehicles tires during static loading, acceleration, and deceleration.

FIG. 12 shows an emergency avoidance steering maneuver used as the input to the simulation.

FIG. 13 shows a schematic of a trailbraking simulation model.

FIG. 14 is a plot of the implementation of trailbraking.

FIG. 15 shows three different brake profiles utilized to advantage.

FIG. 16 shows a diagram illustrating distance saved.

FIG. 17 shows a diagram of yaw rate overshoot.

FIG. 18 shows a plot of the brake force versus the brake pressure.

FIG. 19 shows a plot of the lateral position of a vehicle versus the longitudinal position for a vehicle traveling 100 kph with various brake pressures.

FIG. 20 shows a 3-D graph of the compiled distance saved information across the full range of tested velocities and brake pressures.

FIG. 21 shows a graph of the distance saved versus the velocity for brake profile 1.

FIG. 22 shows a plot of the distance saved versus brake pressure for a vehicle with an initial speed of 100 kph.

FIG. 23 shows a plot of the brake force against the slip ratio for a vehicle with an initial speed of 100 kph.

FIG. 24 shows a plot of the brake pressure versus the slip ratio for a vehicle with an initial speed of 100 kph.

FIG. 25 shows a plot of the lateral force versus the brake pressure for a vehicle with an initial speed of 100 kph.

FIG. 26 shows a plot correlating brake pressure and tire slip.

FIG. 27 shows a plot of the distance saved when the brake pressure is set to the recommended brake pressure for the 3 different brake profiles.

FIG. 28 shows a control algorithm utilizing brake pressure as a function of vehicle speed.

FIG. 29 shows a graph demonstrating trailbraking effectiveness.

FIG. 30 shows a block diagrammatic view of a trailbraking control system according to the present invention.

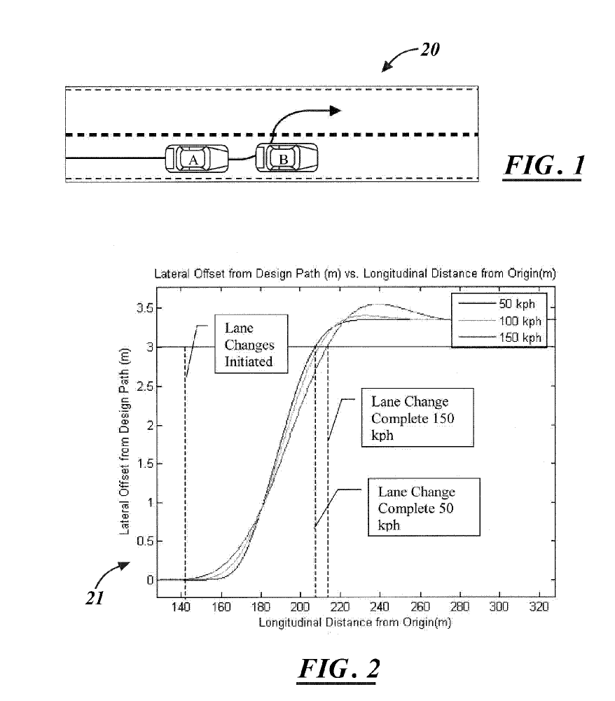

### DETAILED DESCRIPTION OF THE INVENTION

In the following description, various operating parameters and components are described for one or more constructed embodiments. These specific parameters and components are included as examples and are not meant to be limiting.

Trailbraking increases the responsiveness of a vehicle and may be used during an emergency avoidance maneuver to decrease the longitudinal distance traveled during the maneuver. Trailbraking provides increased responsiveness by applying a small amount of braking that causes weight to transfer to the front of the vehicle. This in turns allows the front tires to handle higher lateral forces, which allow the vehicle to perform a turn quicker. Advantageously, trailbraking may also reduce vehicle speed. The slower a vehicle is traveling, the less distance it will need to perform a lane change, as illustrated in FIG. 2. Also, in implementation, trailbraking may be combined with a collision avoidance system to further enhance its usefulness.

The example embodiments utilizing the present invention to advantage are presented below and are modeled upon simulated vehicle criterion. It is believed that a person having skill within the art of active vehicle systems may implement the present invention for advantage. Before turning to the simulation and the example embodiment, the related vehicle dynamics and a small car model used in CarSim to model the dynamic behavior of the vehicle will now be discussed. As mentioned, a small car model in CarSim, Ver 5.16b, computer software produced by Mechanical Simulation Corporation, was used to model the dynamic behavior of the vehicle.

The basic vehicle dynamics equations for trailbraking are detailed below.

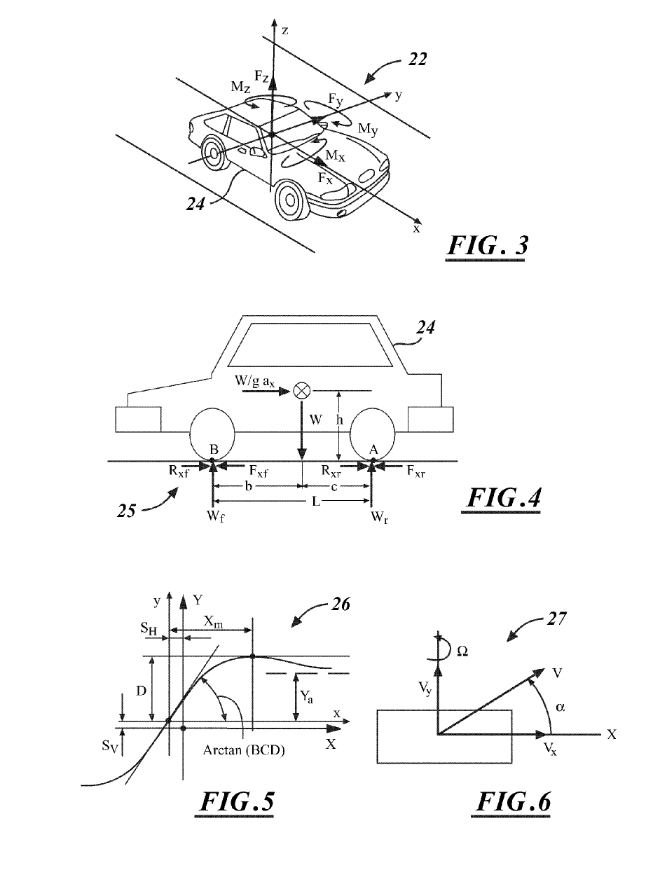

FIG. 3 shows a vehicle coordinate system 22. The coordinate system includes the longitudinal direction X defined as pointing out from the front of a vehicle 24. The lateral direction Y positive pointing to the left of the vehicle 24, and the vertical direction Z defined as positive pointing up. The coordinate system 22 includes corresponding moments Mₓ, M_{y}, and M_{z}, respectively.

FIG. 4 shows a free body diagram 25 of vehicle forces. Neglecting drag forces, and assuming that the vehicle 24 is on a level ground and not towing anything, the forces on a vehicle are represented by: W being the weight of vehicle, W_{f} being the weight on the front axle, Wr being the weight on the rear axle, R_{xf} being the rolling resistance force on the front wheels, Rₓᵣ being the rolling resistance force on the rear wheels, F_{xf} being the tractive force on the front wheels, Fₓᵣ being the tractive force on the rear wheels, g being the gravity constant, ax being the Longitudinal acceleration of the vehicle, b being the distance from the front axle to the center of gravity of the vehicle, c being the distance form the rear axle to the center of gravity of the vehicle, h being the distance from the center of gravity to the ground, and L is the wheelbase of the vehicle.

If the sum of the moments around point A is taken and set equal to zero and the resulting equation is then solved for W_{f}, the following equation for the weight on the front axle of a vehicle during acceleration is derived.

$${W}_{f} = ( Wc - \frac{W}{g} {a}_{x} h ) / L \qquad ( 1 )$$

Similarly if you take the sum of moments about point B, set them equal to zero and solve for Wᵣ, the following equation for the weight on the rear axle of a vehicle during acceleration is derived.

$${W}_{r} = ( Wb + \frac{W}{g} {a}_{x} h ) / L \qquad ( 2 )$$

As is noticed within these equations—and central to the idea of trailbraking as an active system—is the fact that as you apply braking the weight on the front axle gets larger and the weight on the rear gets smaller. Basically, as the vehicle decelerates, there is a transfer of weight to the front wheels from the rear.

In order to simulate the forces on the tire of a vehicle, a tire model is needed. There are many tire models, one acceptable to many vehicle engineers is the Pacejka “Magic Formula” Tire Model, SAE Technical Paper Series 870421, 1987. CarSim uses a slightly modified version of this model and refers to its version of the tire model as the MSC tire model. What follows below is a basic introduction to the tire model. The general form of the Magic Formula is given by:
y(x)=D sin(C tan⁻¹(Bx−tan⁻¹(Bx))) (3)
with
Y(X)=y(x)+Sᵥ (4)
x=X+Sₕ (5)

In equations 3 through 5, Y(X) is the output variable (longitudinal force, the aligning moment or the lateral force), X is the input variable (slip or slip angle), B is the stiffness factor, C is the shape factor, D is the peak factor, E is the curvature factor, Sᵥ is the vertical shift, and Sₕ is the Horizontal shift. FIG. 5 shows the basic curve 26 produced by the Magic formula and the coefficient's effects on the curve.

Calculation of lateral tire forces may be simulated using the Magic Formula. In order to calculate the lateral force on a tire, the lateral tire parameters must first be calculated. They are calculated as follows:

The lateral peak factor D_{y} is given by
D_{y}=μ_{ym}F_{z} (6)
with
μ_{ym}=a₁F_{z}+a₂ (7)
B_{y}C_{y}D_{y}=a₃ sin(2 tan¹F_{z}/a₄))(1−a₅|γ|) (8)

The shape factor C_{y} is found by
C_{y}=a₀ (9)

The stiffness factor can be found by dividing the second equation above by C_{y} and D_{y}

$${B}_{y} = \frac{{B}_{y} {C}_{y} {D}_{y}}{{C}_{y} {D}_{y}} \qquad ( 10 )$$

The curvature factor E_{y} is found from
E_{y}=a₆F_{z}a₇ (11)

The horizontal S_{hy} and vertical S_{vy} shift parameters are given by
S_{hy}=a₈γ+a₉F_{z}+a₁₀ (12)
and
S_{vy}=a₁₁F_{z}γ+a₁₂F_{z}+a₁₃ (13)

In equations 6 through 13, F_{z} is the normal force on the tire, μ_{ym} is the lateral friction coefficient, and γ is the tire camber angle. a₀ through a₁₃ are the 4 lateral tire coefficients, that are required by the Magic Formula. These parameters are obtained by fitting curves to tire test data. Typical values for front wheel drive car are shown in Table 1.

TABLE 1
Lateral Tire Coefficients

| | a₀ | a₁ | a₂ | a₃ | a₄ | a₅ | a₆ | a₇ | a₈ | a₉ | a₁₀ | a₁₁ | a₁₂ |
|---|---|---|---|---|---|---|---|---|---|---|---|---|---|
| Value | 1.69 | −55.2 | 1271 | 1601 | 6.49 | 0.005 | −0.38 | 0.0042 | 0.086 | −7.97 | −0.22 | 7.66 | 45.8 |

Combining equations 6 through 13, the lateral force for pure sideslip F_{yo} is given by

$$\begin{matrix}{F}_{yo} ( α ) = {D}_{y} sin \{ {C}_{y} {tan}^{- 1} ( {B}_{y} [ α + {S}_{hy} ] - {E}_{y} ( {B}_{y} [ α + {S}_{hy} ] - {tan}^{- 1} ( {B}_{y} [ α + {S}_{hy} ] ) ) ) \} + {S}_{vy} \\ with & ( 14 ) \\ α = {tan}^{- 1} ( \frac{- {V}_{y}}{{V}_{x}} ) & ( 15 )\end{matrix}$$

In equations 14 and 15, a is the lateral slip angle, Vₓ is the longitudinal component of vehicle speed V_{y} is the lateral component of vehicle speed, and Ω is the wheel rotational velocity. FIG. 6 shows a coordinate 27 for tire slip angle properties.

Of central importance to these equations for their potential effect on trailbraking is that in equation 6, as F_{z} is increased, D_{y} follows. This in turn causes F_{y0} to increase (equation 14). That is, as the weight on the tire is increased, the lateral force also increases. However, this relationship is not a linear one and only holds true up to a certain point. FIG. 7 shows a sample plot 28 of lateral force versus slip angle for a 195/65 R15 tire that was modeled using the Magic Formula. This plot 28 shows the relationship between the weight on the tire and the lateral force that is generated. In this tire example, as the weight is increased from 2000 to 7000 N, the absolute value of the lateral force that is generated increases as well.

Similarly, calculation of longitudinal tire forces may be simulated using the Magic Formula. To find the longitudinal force on the tire the longitudinal parameters must be calculated. They are determined as follows:

The longitudinal peak factor Dₓ is given as
Dₓ=μₓₘF_{z} (16)
with
μₓₘ=b₁F_{z}+b₂ (17)

The slope at small slip ratios is found using
BₓCₓDₓ=(b₃F_{z}²+b₄)e⁻^{₅}^{F}^{_{z}} (18)
where the shape factor is taken to be
Cₓ=b₀ (19)

Solving for Bₓ gives

$${B}_{x} = \frac{{B}_{x} {C}_{x} {D}_{x}}{{C}_{x} {D}_{x}} \qquad ( 20 )$$

The curvature factor Eₓ is found using
Eₓ=b₆F_{z}²+b₇F_{z}+b₈ (21)
and the offsets are taken to be
Sₕₓ=b₉F_{z}+b₁₀ (22)
and
Sᵥₓ=0 (23)

In equations 16 through 23, μₓₘ is the longitudinal friction coefficient. b₀ through b₁₀ are the longitudinal tire coefficients for the Magic Formula. As with the lateral forces, these coefficients are found by curve fitting tire test data obtained at various vertical loads and longitudinal slips with the lateral slip equal to zero. Typical Values of these coefficients for a small car are shown in Table 2.

TABLE 2
Longitudinal Tire Force Coefficients

| | b₀ | b₁ | b₂ | b₃ | b₄ | b₅ | b₆ | b₇ | b₈ | b₉ | b₁₀ |
|---|---|---|---|---|---|---|---|---|---|---|---|
| Value | 1.65 | −7.6 | 1122.6 | −0.007 | 144.8 | −0.007 | −0.0038 | 0.085 | −0.076 | 0.023 | 0.023 |

Combining the equations above, the longitudinal force for pure longitudinal slip is given by

$$\begin{matrix}{F}_{x 0} ( κ ) = {D}_{x} ( sin {C}_{x} {tan}^{- 1} ( {B}_{x} [ κ + {S}_{hx} ] - {E}_{x} ( {B}_{x} [ κ + {S}_{hx} ] - {tan}^{- 1} ( {B}_{x} [ κ + {S}_{hx} ] ) ) ) ) \\ with & ( 24 ) \\ κ = \frac{- {V}_{sx}}{{V}_{x}} & ( 25 ) \\ {V}_{sx} = {V}_{x} - Ω {r}_{e} & ( 26 )\end{matrix}$$

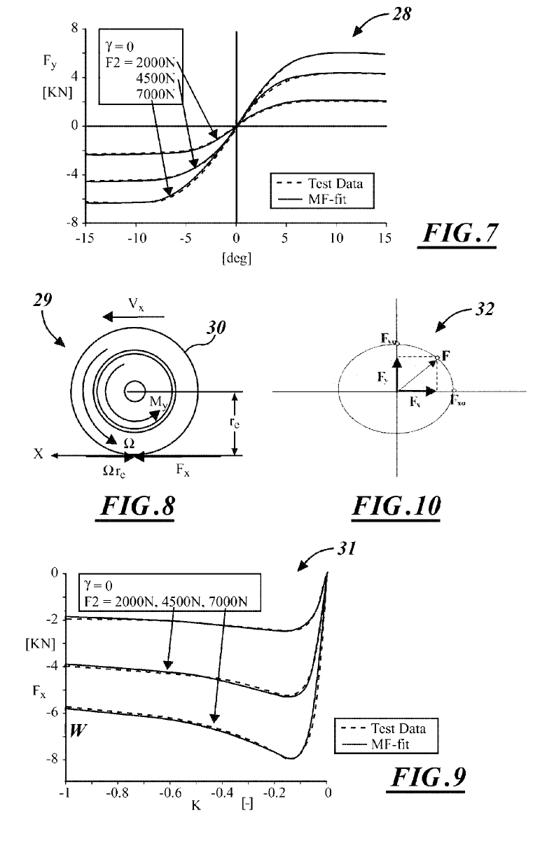

In equations 24 through 26 K the longitudinal slip, Vₓ is the longitudinal speed of wheel hub, Vₛₓ is the slip velocity of the hub in the longitudinal direction, Ω is the wheel rotational velocity, and rₑ is the effective rolling radius of the tire. These coefficients are shown in FIG. 8. FIG. 8 shows factors 29 affecting longitudinal slip of a tire 30.

Similar to the case with lateral forces, as the weight on a tire is increased, so is the longitudinal force that is generated (equation 16 and 24). However, unlike the lateral force model, this relationship is not linear. FIG. 9 shows a sample plot 31 of longitudinal force versus slip angle for a 195/65 R15 tire that was modeled using the Magic Formula. Plot 31 shows the relationship between the weight on the tire and the longitudinal force that is generated. In this example, as the weight is increased from 2000 to 7000 N, the absolute value of the longitudinal force that is generated is also increased.

Calculation of the aligning moment using the Magic Formula may also be accomplished. However, a detailed discussion may be acquired by referring to an applicable text on the subject, such as “Tyre and Vehicle Dynamics”, because the aligning moment is not essential to the present invention.

Calculation of combined tire forces may now be accomplished by using the friction circle. For a complete analysis of the tire forces using trailbraking, a combined force tire model is needed. For simple calculations, using a friction circle or a friction ellipse approximation will give decent results and will be sufficient for discussion purposes. The friction circle provides for a rough estimation of the interaction between the lateral tire forces F_{y} and the longitudinal tire forces Fₓ.

$${( \frac{{F}_{y}}{{F}_{y 0}} )}^{2} + {( \frac{{F}_{x}}{{F}_{x 0}} )}^{2} = 1 \qquad ( 27 )$$

The resultant force F is given by
F=\sqrt{Fₓ²+F_{y}²} (28)

In equations 27 and 28, F_{y0} is the lateral force exerted at a given sideslip angle when no longitudinal force Fₓ is exerted, and Fₓ₀ is the maximum longitudinal force exerted at zero sideslip angle. The friction circle 32 is shown graphically in FIG. 10.

Examining equation 27 closer, it becomes evident that as F_{y} is increased, then Fₓ is decreased. As the lateral force is increased, the available longitudinal force is decreased. This indicates that the maximum F_{y} is obtained when there is no braking, which in turn would indicate that there is no need to perform trailbraking. This would be true if trailbraking always operated just at the edge of adhesion. This is not the case however. Lane change maneuvers on are not typically performed with the maximum level of lateral force F_{y0}. Consequently, when the braking is applied, there is a set amount of braking that can be applied to generate longitudinal force Fₓ without decreasing the lateral force. In addition, as discussed earlier, the application of this braking force has the tendency to shift weight to the front axle of the vehicle, which in turn increases the lateral force F_{y} on the front tires. The net effect is that with the use of trailbraking for an emergency avoidance maneuver, the lateral force F_{y} is increased.

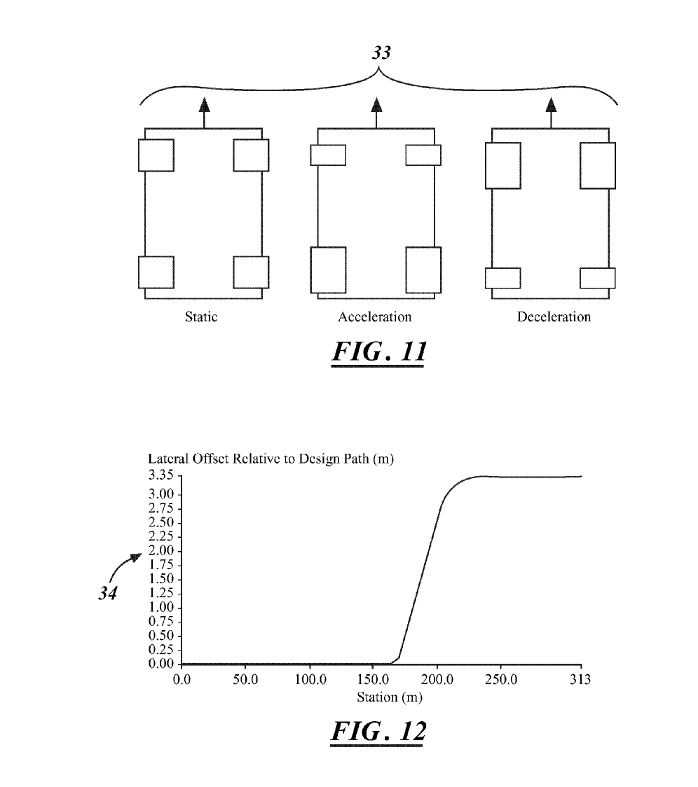

The reason that weight transfer to a tire increases the tires ability to generate lateral force is because of its increased contact patch. The contact patch is the part of the tire that is in contact with the ground. It is this contact with the ground that provides traction for the vehicle. The larger the contact patch, the more traction the tire will have with the road. Assuming the tire is in contact with a hard surface, as the weight on a tire increases, the tire compresses and more of the tire is in contact with the ground. Therefore the contact patch of the tire is larger. When the weight on a tire decreases, the reverse is also true. FIG. 11 shows a diagram 33 representing contact patch for vehicles tires during static loading, acceleration, and deceleration. During static or steady-state loading, the tires contact patches will be at their nominal size. As the vehicle accelerates, weight is transferred to the rear axle. This increases the size of the contact patch in the rear and decreases it in the front. During deceleration, the vehicle pitches forward, transferring more weight to the front of the vehicle. This increases the size of the contact patch on the front tires and decreases it on the rear tires. The larger contact patch on the front tires allows more grip to be generated, and thus more lateral force. This will allow a vehicle to make a lane change faster.

The computer simulation using CarSim is now discussed.

The purpose of the computer simulation was to verify the feasibility of the trailbraking concept as an active system device. CarSim is a vehicle dynamics modeling program that allows you to modify many of a vehicles attributes. The underlying equations of the program applicable to the present invention are based on some of the vehicle dynamics equations discussed above. As mentioned, CarSim's small car vehicle model was used for the simulations.

FIG. 12 shows an emergency avoidance steering maneuver 34 used as the input to the simulation. In order to keep the input consistent the same steering input was applied for all scenarios, regardless of the speed or the brake pressure. In the steering maneuver, at approximately 160 m, the steering maneuver is started, and in the nominal case it is complete at 207 m. This is the design target, but based on the speed of the vehicle, the braking and other factors, the vehicle may take more or less distance to perform the lane change maneuver.

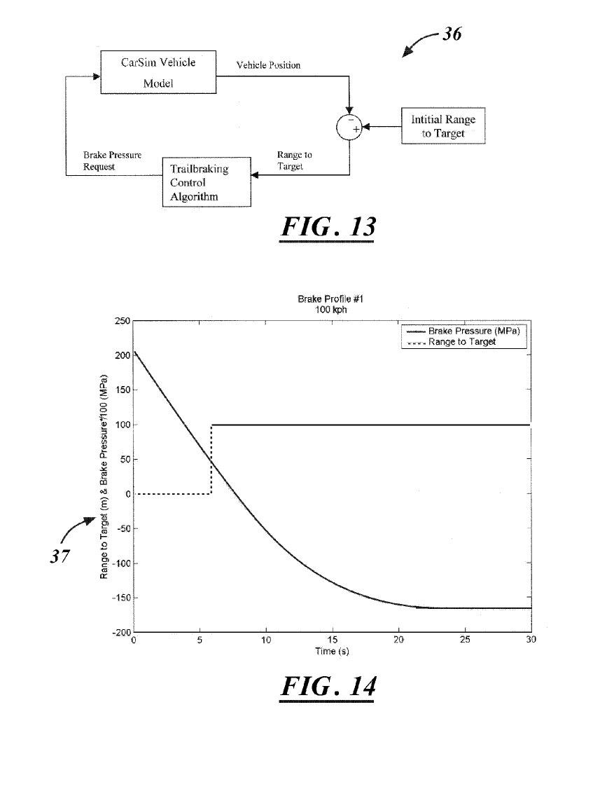

FIG. 13 shows a schematic of a trailbraking simulation model 36. The model 36 using the vehicle dynamics of the model provided the output of the longitudinal vehicle position. The longitudinal vehicle position was then compared to the initial range to the target, to get the current range to the target. For this study, the initial range to the target was set to 207 m for all of the tests. This coincides with the nominal distance that it takes to initialize and complete the lane change maneuver 34 shown in FIG. 12. Next, the trailbraking control algorithm examines the range to the target. If the range to the target drops below 47 m, trailbraking is implemented and a brake request is sent back to the CarSim vehicle model. The brake pressure that is requested is divided evenly between each of the four wheels brakes. The 47 m range threshold roughly corresponds to the point at which an unaided vehicle would have to begin a steering maneuver to avoid the accident without braking in this simulation.

FIG. 14 is a plot 37 of the implementation of trailbraking. The plot 37 shows the range to the target and the brake pressure versus the time. As can be seen from the plot 37, as the event initially starts, there is no braking, and once the vehicle passes within 47 m of the target, a brake pressure of 1 MPa is implemented.

Development of a control strategy for trailbraking.

In order to have a comparison point to measure the effectiveness of trailbraking, a baseline run is needed. A simulation was run in which the emergency steering maneuver was the input, but no braking was applied. This run gives a comparison point for how much longitudinal distance is needed for a basic lane change without braking. It was performed for speeds ranging from 10 to 200 kph.

The tunable parameters of the trailbraking model that were studied are now discussed. These tunable parameters may alter the effectiveness of trailbraking by changing their value, or their implementation. The tunable parameters are control signal, braking pressure or applied profile, and braking magnitudes. Also additional parameters of vehicle speed, and lane change maneuvering are considered.

Control signal for trailbraking: To properly implement trailbraking, a control signal needs to be carefully chosen. This is the signal that will be used to trigger trailbraking if certain conditions are met. For the purposes of the computer simulations the range to target was chosen. When the range to the target falls below 47 m, the trailbraking algorithm is implemented. This roughly corresponds to the point in which a vehicle would need to start a steering maneuver to avoid an accident if there was no trailbraking applied. This is only one of many triggers that can be chosen, and it is recognized that by choosing 47 m as the implementation point invokes other limitations for simulation. It is recognized for the simulation, at higher speeds, it takes more longitudinal distance to actually perform a lane change maneuver than at slower speeds. This can lead to the perception that the trailbraking is being implemented late at higher speeds if a constant range is used. Also, using the range does not take into account that the target vehicle is moving. Because of this, the relative velocity should also be taken into account.

Alternative control signals could be based on lateral acceleration or a combination of the relative speed, relative acceleration and range-to-target. An implementation based on lateral acceleration alone would suffer because the trailbraking would not start until the turn has already started. Also, the threshold would have to be set sufficiently high, so that trailbraking does not start when a normal lane change is occurring. Using a combination of the relative speed, relative acceleration and range-to-target information as a trigger would probably provide better results.

In a vehicle implementation, the target vehicle's dynamic information could be gathered from a forward looking sensing system that would monitor and track the target vehicle and provide information on its whereabouts.

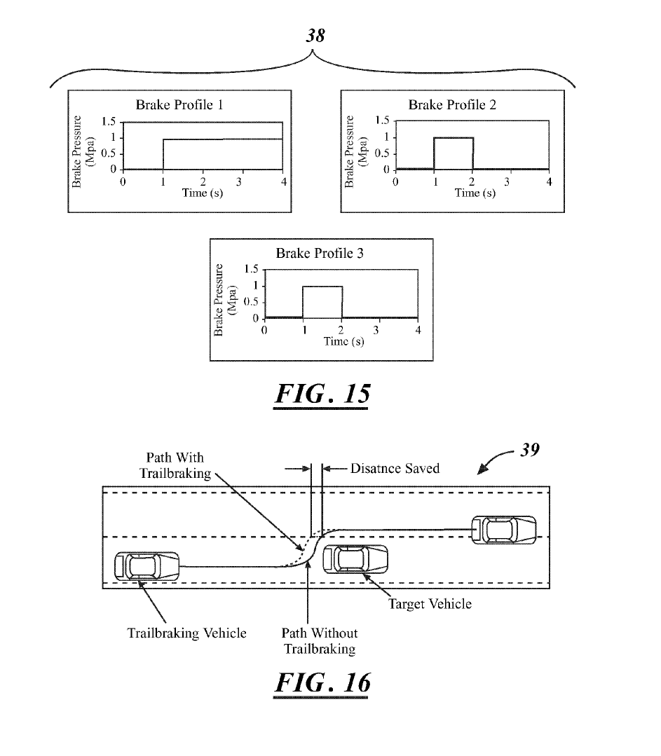

Brake profiles studied for trailbraking implementation: another important tunable parameter when designing the system is the braking profile that will be used. For the purposes of the computer analysis, FIG. 15 shows three different brake profiles 38 utilized to advantage. The first brake profile is a step response that is applied and continues until the vehicle comes to a stop. The second profile is a step response that applies the brakes for one second and the third is a step response that applies the brakes for two seconds. These profiles were chosen to investigate what effect the braking duration has on the implementation of trailbraking. For all three of these profiles, an equal brake pressure of 1 MPa is always requested from each of the wheel corners.

Applying equal brake pressure to all four wheel corners will tend to have a destabilizing effect at higher brake pressures. However, the brake pressure needed to bring the front axle to lockup is higher than the brake pressure needed to bring the rear of a vehicle to lockup. It is beneficial to bring both axles to lockup simultaneously which is achieved in production vehicles through brake proportioning. If equal pressure is applied to all four wheels, the rear axle will lock up first, which will cause the vehicle to become unstable at higher speeds. Accordingly, it is recognized that the effects of applying different pressures to the different corners is of consideration. While certain profiles are utilized, it is recognized that other profiles varying brake pressure, duration may be utilized to advantage, including different ramp up and ramp down profile types. Also recognized, is that the braking pressure may be gradually reduced to create better results than letting the pressure off all at once.

Braking magnitudes studied for trailbraking implementation: The braking magnitude used will affect the overall results of implementing trailbraking. As such, magnitude was one of the main focuses of study in the computer simulations. For each speed and brake profile, the model was simulated with brake pressure ranging from 0 to 8 MPa, in increments of 0.1 MPa, to determine which brake pressures were optimal for which speeds.

Turning now to the additional parameters that may be considered for a trailbraking system.

Initial speed of trailbraking equipped vehicle: the speed at which a vehicle is moving will affect the distance in which that vehicle can perform an emergency lane change maneuver. As the speed goes up, the distance needed increases for the case with no trailbraking, as was shown in FIG. 2. The vehicle speed also will have an effect on the implementation of trailbraking. Trailbraking is more effective at certain speeds than at others for a variety of reasons, which will be discussed below.

Briefly however, at lower speeds, the vehicle can never achieve full results from trailbraking because the vehicle will come to a stop at the higher brake pressures, which tend to produce the best results. At higher speeds, the vehicle tends to become unstable at the higher brake pressures. The brake pressure will need to be carefully selected for each vehicle speed in order to find an optimum implementation of trailbraking.

Lane change maneuvers: the lane change maneuver itself is a highly variable input. For the purposes of the above-mentioned situation, the lane change maneuver is fixed for all simulations. In actual implementation however, the driver has ultimate control over this input and each driver reacts differently. Driving styles differ greatly between men and women, and the young and old. For this reason, implementation of trailbraking will need to be tuned ensuring stability is maintained for a particular steering input, or at least the vehicle is as stable as it would have been without trailbraking.

Metrics used to assess the performance of trailbraking are distance saved and yaw rate overshoot. To properly study the effects of implementing trailbraking, viable metrics are derived to compare the functionality of a vehicle with and without trailbraking. Each of the metrics used for this study are now discussed.

Distance saved: the main goal of trailbraking is to reduce the amount of longitudinal distance needed to perform a lane change maneuver. As such, the concept of ‘Distance Saved’ is introduced. Distance saved is the amount of longitudinal distance that can be saved by performing a lane change maneuver with trailbraking implemented as compared to performing the same lane change maneuver without trailbraking. FIG. 16 shows a diagram 39 illustrating distance saved. As the amount of distance saved increases, so does a vehicles ability to avoid an accident, recognizing of course this relationship is limited by the stability of the vehicle.

Yaw rate overshoot: another of the objectives of trailbraking is to make sure that when implementing trailbraking, the vehicle remains stable. A metric that is used to compare the stability of a vehicle during lane change tests is the yaw rate overshoot.

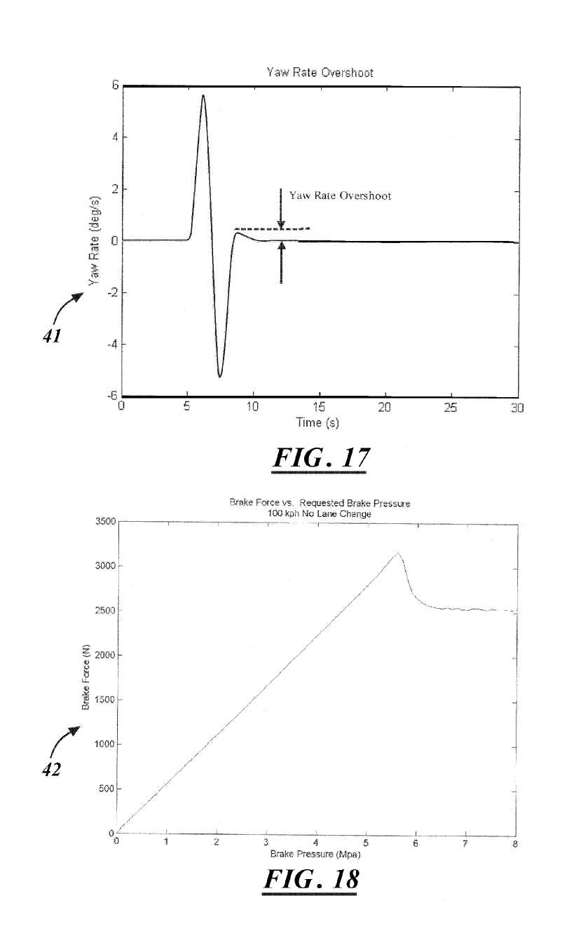

FIG. 17 shows a diagram 41 of yaw rate overshoot. The yaw rate overshoot is a measure of how quickly a vehicle settles down in the other lane after a lane change is performed. If the yaw rate overshoot is too high, the vehicle will become unstable. For the purposes of the simulation model, if the yaw rate overshoot was above 5 deg/s the vehicle was considered unstable. Yaw rate overshoots below 5 deg/s were considered stable, and yaw rate overshoots below 2 deg/s were recommended as is shown in Table 3. While these stability ranges are reasonable, for actual implementation on a particular vehicle a proper determination should be conducted for the effects of trailbraking on stability. It should be recognized that in an actual implementation, the stability values for a vehicle may be determined for example by testing, and could vary from the values used for the simulation results presented here.

TABLE 3
Yaw Rate Overshoot Acceptance Criteria

| | |
|---|---|
| Yaw Rate Overshoot > 5 deg/s | Unstable |
| 5 > Yaw Rate Overshoot > 2 | Stable |
| 2 > Yaw Rate Overshoot | Recommended |

As mentioned earlier, stability is mainly a factor at higher speeds and higher brake pressures. At the higher speeds and brake pressures, it is possible to achieve increased distance saved, but the vehicle may not remain stable.

Another metric that could be used to measure stability is the aligning moment. As the braking limit is approached, the braking forces cause the aligning moment to decrease to the point that it changes its sign. This effect is destabilizing, as it tends to increase the sideslip angle.

Now turning to results produced by the simulation for trailbraking.

As a starting point, it is useful to determine the relationship between the applied brake pressure and the resulting brake force. FIG. 18 shows a plot 42 of the brake force versus the brake pressure. The brake force holds a linear relationship with the applied brake pressure up until just over 5 MPa. After this point, the tires saturate, and the brake force decreases slightly and levels out.

The simulation results for brake profile 1 will be looked at in depth, and then compared to the results from profiles 2 and 3. As a reminder, brake profile 1 applies a step input to the brakes and holds it until the vehicle comes to a complete stop.

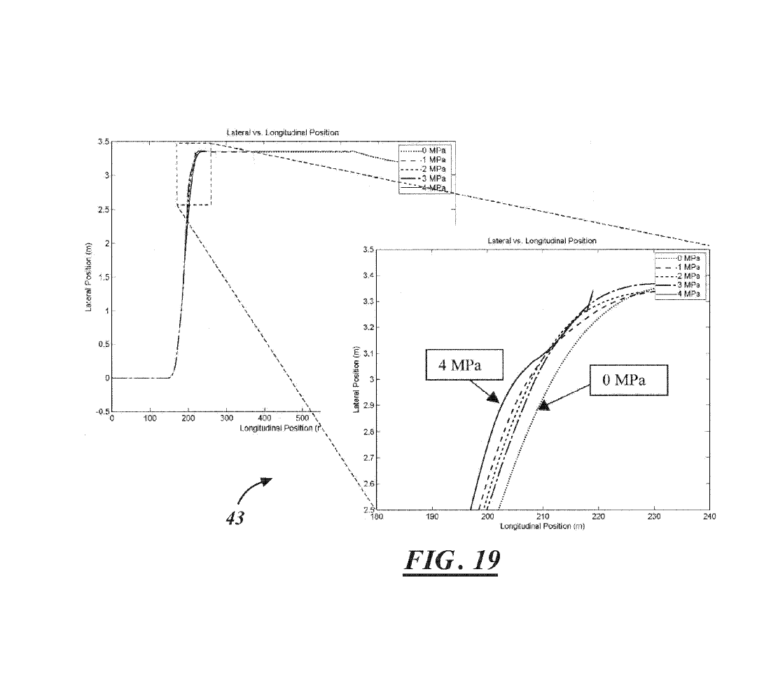

FIG. 19 shows a plot 43 of the lateral position of a vehicle versus the longitudinal position for a vehicle traveling 100 kph with various brake pressures. As can be seen from the plot 43, as trailbraking is implemented, the amount of longitudinal distance needed to perform a lane change is decreased.

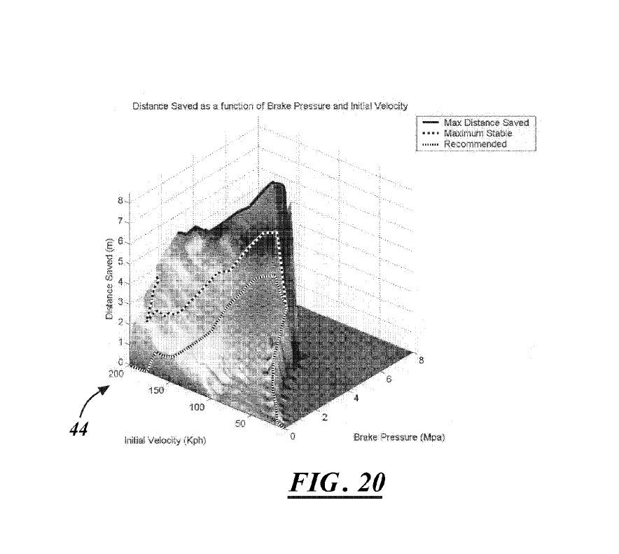

FIG. 20 shows a 3-D graph 44 of the compiled distance saved information across the full range of tested velocities and brake pressures. The graph 44 shows the distance saved versus the initial velocity and the brake pressure applied via trailbraking. Taking a look at the plot for this brake profile, trailbraking has the greatest effect in the 90-120 kph range.

Initially it was thought that for all speeds, as the brake pressure increased, the maximum distance saved would also go up. This turned out not to be the case however. The simulation shows that there is an optimal brake pressure for each speed. At the lower speeds (below 80 kph) the optimum brake pressure corresponds to the maximum pressure that can be applied and still have the vehicle complete the lane change maneuver. At the higher speeds the pressure that yields the maximum distance saved is limited by stability in the chosen stable or recommended ranges.

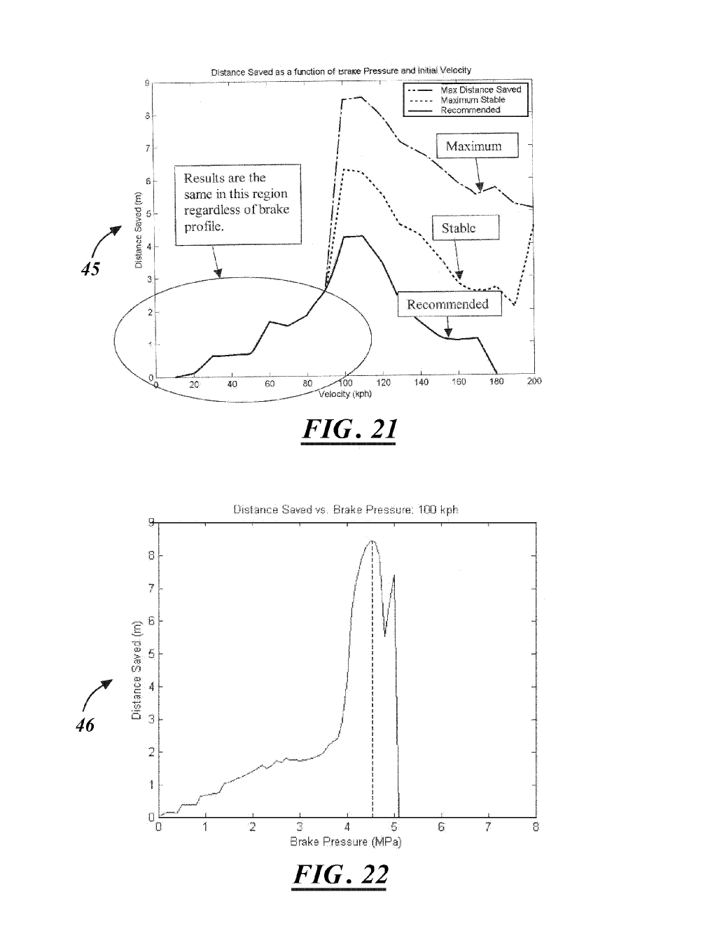

FIG. 21 shows a graph 45 of the distance saved versus the velocity for brake profile 1. Using the brake pressures within the recommended range, the maximum distance saved occurs at 100 kph and is just over 4 m. That is, the distance needed to perform a lane change maneuver is 4 m lower when using trailbraking than without. The recommended brake pressure for 100 kph speed is 1.9 MPa. The brake pressure that yields the maximum distance saved is 4.5 MPa and provides a distance saved over 8 m. These results show that even by decreasing the brake pressure to the recommended range, trailbraking can have an effect on the distance needed to perform a lane change maneuver.

To take advantage of trailbraking, the stability of the vehicle needs to be taken into account. To do this, the yaw rate overshoot (see FIG. 17) for each run at the different speeds and brake pressure was calculated to determine what is the maximum brake pressure that could be applied at each speed and still yield a recommended or stable result. The cut off used for the simulation was that if the yaw rate overshoot was under 5 deg/s it was considered stable. It is recognized that in actual application, attention to stability in order to formulate a recommended brake pressure for a particular speed is needed. Also, consideration to other factors needs to be given for optimization of the particular trailbraking device, because this simulation was done using only a single steering profile and does not take into account different driver styles. As such, the recommended brake pressures correspond to the maximum pressure that can be applied and still keep the yaw rate overshoot under 2 deg/s. For brake profile 1 and speeds under 90 kph used in the simulation, the vehicle is not unstable and as such, the recommended pressure is the same as the maximum pressure in this region.

Also of interest was to determine if the maximum distance saved correlated to a consistent slip ratio across the vehicle speeds. In order to determine this, plots of the brake force vs. slip ratio, brake pressure vs. slip ratio, distance saved vs. brake pressure and lateral force vs. brake pressure were examined for speeds between 50 and 200 kph. For speeds lower than 50 kph, the vehicle comes to a stop before the lane change is complete. To demonstrate how the correlation was done, the case with the initial vehicle speed of 100 kph will be used with brake profile 1.

FIG. 22 shows a plot 46 of the distance saved versus brake pressure for a vehicle with an initial speed of 100 kph. This plot shows that the maximum distance saved occurs when the brake pressure is set to 4.5 MPa at all four wheels.

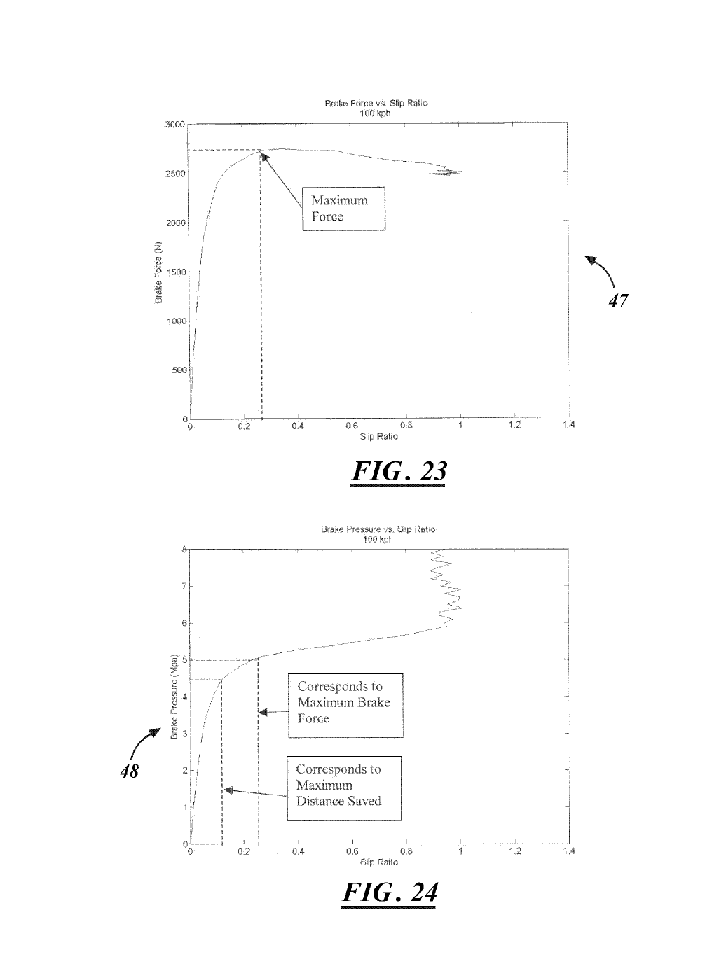

FIG. 23 shows a plot 47 of the brake force against the slip ratio for a vehicle with an initial speed of 100 kph. From the plot 47, it can be seen that the maximum brake force occurs when the slip ratio is approximately 0.24.

FIG. 24 shows a plot 48 of the brake pressure versus the slip ratio for a vehicle with an initial speed of 100 kph. The plot 48 demonstrates that when the slip ratio is 0.24 (slip ratio that correlates to the maximum brake force) the applicable brake pressure is approximately 5 MPa. Also, it can be seen that when the brake pressure is set to 4.5 MPa (correlates to maximum distance saved), there will be a slip ratio of approximately 0.14.

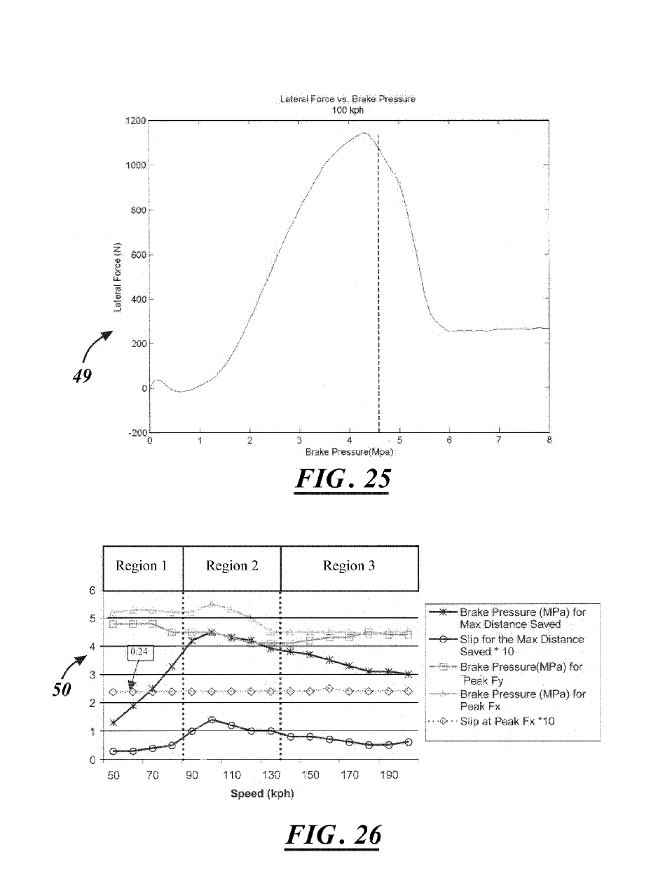

FIG. 25 shows a plot 49 of the lateral force versus the brake pressure for a vehicle with an initial speed of 100 kph. This plot 49 reveals that for the 100 kph initial velocity case, the maximum lateral force is achieved when the brake pressure is approximately 4.3 MPa.

The results of this analysis are given in FIG. 26 showing a plot 50 correlating brake pressure and tire slip. Looking at the line corresponding to the slip ratio at the peak brake force for each speed, it can be seen that the slip value stays relatively constant at about 0.24. This means that regardless of the speed, the maximum brake force occurs with about the same amount of tire slip. Of particular interest, as shown in plot 50, is the fact that in region 2 (90-140 kph), the brake pressure that leads to the maximum distance saved closely follows the brake pressure that leads to the greatest lateral force. That is, at this brake pressure, the greatest steering force can be generated. This was the result that was expected for the entire range of speeds, but this is not the case. In region 3 (>140 kph), as previously noted, the stability of the vehicle comes into play. In this region, the vehicle becomes unstable at brake pressures lower than those that would provide the maximum lateral force for trailbraking. This result indicates that if trailbraking may be enhanced in region 3 if used in conjunction with a stability control device. In region 1 (0-90 kph), the brake pressure that leads to the maximum distance saved is lower than that which leads to the maximum lateral force because the vehicle will come to a stop before a lane change is completed at the higher brake pressures and lower speeds. Also in region 2, the slip ratio that corresponds with the maximum distance saved reaches its peak, which is still substantially lower than the slip ratio at the maximum brake pressure. It is noted that while regions 1, 2 and 3 have particular speed ranges indicative of the results for the simulation model, it is expected that the ranges will differ in actual implementation.

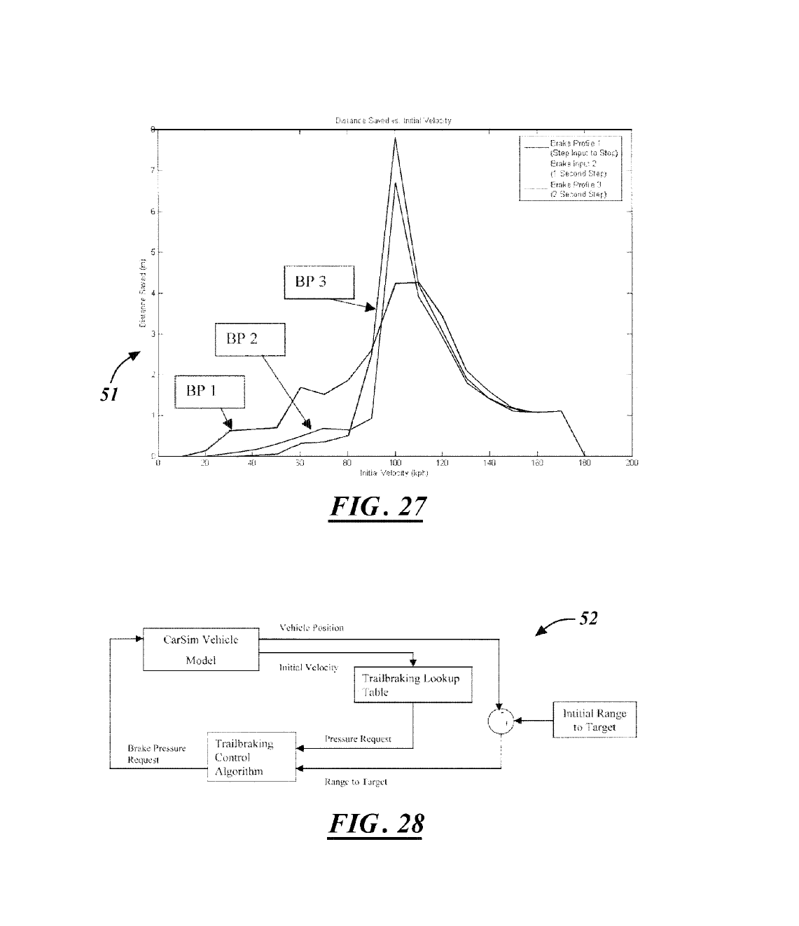

The results of the utilized brake profiles 1, 2 and 3 are now compared. FIG. 27 shows a plot 51 of the distance saved when the brake pressure is set to the recommended brake pressure for the 3 different brake profiles. For initial speeds below 90 kph, brake profile 1 (brakes until the vehicle stops) provides the best results. In the 90 to 110 kph range however, it fares much worse than the other two brake profiles tested. In this range, brake profile 3 (brake for 2 seconds) worked better than brake profile 2 (brake for 1 second). At speeds above 120 kph all three profiles performed about the same. This was expected, because in this region the stability becomes a influencing factor.

For model implementation of trailbraking consideration may be given to the effectiveness of the system at low speeds versus high speeds. Trailbraking may be implemented in a vehicle by optimizing it for various speed ranges, in particular for higher speed. Given this criterion, brake profile 3 was chosen for the recommended implementation. It gives the best results in the 90 to 120 kph range and provides adequate results at the lower speeds. The brake pressures for the recommended implementation are shown in Table 4. However, it is recognized that segmented or piecewise implementation of brake profiles 1, 2 and 3 may be utilized for improved optimization.

TABLE 4
Brake Pressures Implementation

| | Speed (kph) | | | | | | | | | |
|---|---|---|---|---|---|---|---|---|---|---|
| | 10 | 20 | 30 | 40 | 50 | 60 | 70 | 80 | 90 | 100 |
| Recommended | 0 | 0 | 0.1 | 0.2 | 0.2 | 0.4 | 0.5 | 0.8 | 5.1 | 4.9 |
| Pressure | | | | | | | | | | |
| (MPa) | | | | | | | | | | |

| | Speed (kph) | | | | | | | | | |
|---|---|---|---|---|---|---|---|---|---|---|
| | 110 | 120 | 130 | 140 | 150 | 160 | 170 | 180 | 190 | 200 |
| Recommended | 4.4 | 3.8 | 3.3 | 2.4 | 1 | 0.1 | 0.1 | 0 | 0 | 0 |
| Pressure | | | | | | | | | | |
| (MPa) | | | | | | | | | | |

FIG. 28 shows a control algorithm 52 utilizing brake pressure as a function of vehicle speed. The control algorithm 52 includes a vehicle speed determination in which a brake pressure implementation may be utilized by the trailbraking controller. In this embodiment the brake pressure implementation is in the form of a lookup table. This table will provide the brake pressure that should be requested for the vehicle speed that the host vehicle is traveling.

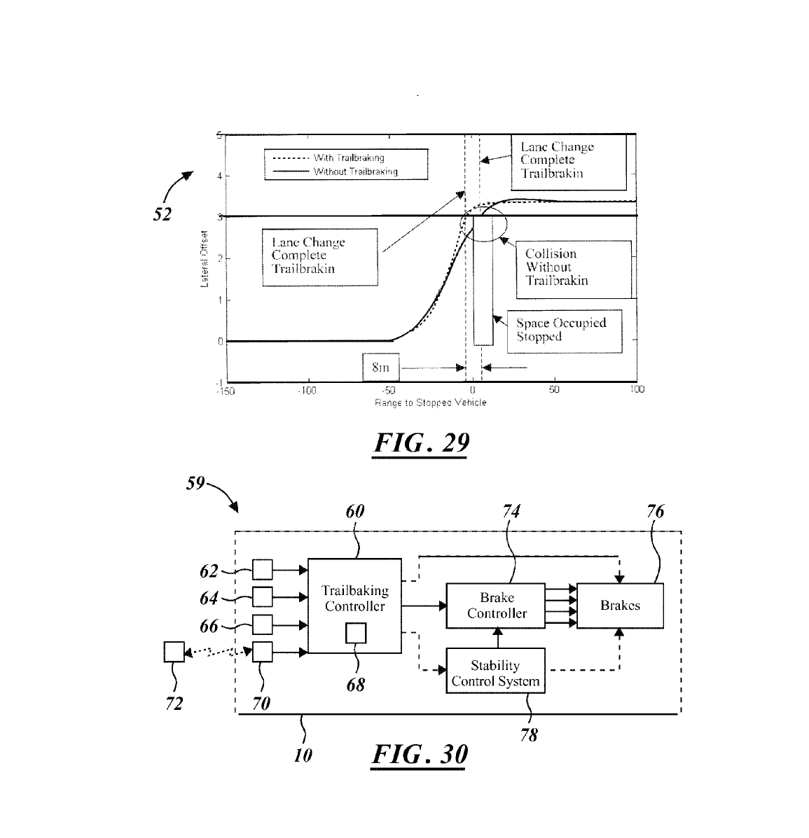

FIG. 29 shows a graph 53 demonstrating trailbraking effectiveness. With trailbraking invoked, a vehicle traveling at 100 Kph, that otherwise might collide with another vehicle, would have taken nearly 8 less meters to perform the same steering maneuver as can be seen in FIG. 29.

Analysis of the underlying equations and the scenario shown in FIG. 29 shows the improvement in lateral force generation. The hand calculations are as given:

With, Cₐ=750 N/deg, b=0.948 m, c=1.422 m, h=0.48 m, L=2.37 m, g=9.8 m/s2, m=940 kg, v=100 kph=27.7 m/s, aₓ=−1.5 m/s2

Equations:

$${W}_{f} = W ( \frac{c}{L} - \frac{{a}_{x} h}{g L} )$$

$${W}_{r} = W ( \frac{b}{L} - \frac{{a}_{x} h}{g L} )$$

$${F}_{yf} = \frac{{W}_{f}}{g} ( \frac{{v}^{2}}{R} )$$

$${F}_{y r} = \frac{{W}_{r}}{g} ( \frac{{v}^{2}}{R} )$$

$${a}_{f} = {W}_{f} ( \frac{{v}^{2}}{{C}_{α f} g R} ) = \frac{{F}_{yf}}{{C}_{α f}}$$

$${α}_{r} = \frac{{F}_{y r}}{{C}_{α r}}$$

Lateral Force Generated Without Braking:

$${W}_{f} = W \frac{c}{L} = 940 kg ( \frac{1.422 m}{2.37 m} ) ( 9.81 \frac{m}{{s}^{2}} ) = 5527 N$$

$${W}_{r} = W \frac{b}{L} = 940 kg ( \frac{0.948 m}{2.37 m} ) ( 9.8 \frac{m}{{s}^{2}} ) = 3684 N$$

$${F}_{yf} = {W}_{f} ( LatAcc ) = 5527 N ( 0.37 g ) = 2044 N$$

$${F}_{y r} = {W}_{r} ( LatAcc ) = 3684 N ( 0.37 g ) = 1363 N$$

Lateral Force Generated With Braking:

$$\begin{matrix}{W}_{f} = W ( \frac{c}{L} - \frac{{a}_{x} h}{g L} ) \\ = 940 kg ( 9 .8 \frac{m}{{s}^{2}} ) ( \frac{1.422 m}{2.37 m} - ( \frac{- 1.5 \frac{m}{{s}^{2}}}{9.8 \frac{m}{{s}^{2}}} ) ( \frac{0.480 m}{2.37 m} ) ) \\ = 5812 N\end{matrix}$$

$$\begin{matrix}{W}_{r} = W ( \frac{b}{L} - \frac{{a}_{x} h}{g L} ) \\ = 940 kg ( 9 .8 \frac{m}{{s}^{2}} ) ( \frac{0.948 m}{2.37 m} + ( \frac{- 1.5 \frac{m}{{s}^{2}}}{9.8 \frac{m}{{s}^{2}}} ) ( \frac{0.480 m}{2.37 m} ) ) \\ = 3400 N\end{matrix}$$

$${F}_{yf} = {W}_{f} ( LatAcc ) = 5812 N ( 0.37 g ) = 2208 N$$

$${F}_{y r} = {W}_{r} ( LatAcc ) = 3400 N ( 0.37 g ) = 1292 N$$

The calculations above show that with braking applied, the front tires of the vehicle can generate more lateral force than if the brakes were not applied, i.e., 2208 N with the brakes applied versus 2044 N without. This will hold true in at least the linear brake force region. This extra lateral force can be used to achieve quicker turns and thus distance saved.

There is also another added benefit of employing trailbraking. Because trailbraking applies the brakes to the vehicle in a situation where the driver attempts to steer around the oncoming obstacle without the driver applying brakes, it has the effect of slowing the vehicle down. Accordingly, trailbraking will further reduce the impact harshness should a collision not be mitigateable.

FIG. 30 shows a block diagrammatic view of a trailbraking control system 59 according to the present invention. The trailbraking control system 59 includes a Trailbraking controller 60 that implements an algorithm based upon sensors output signals to determine the amount of brake pressure required to achieve the performance criterion stated above. Together with the sensor output signals and the algorithm, the trailbraking controller may conditionally output a segmented, proportioned or continuous range of signal or signals to achieve trailbraking of the wheels of a vehicle 10.

Beginning with the trailbraking controller 60 implemented within the vehicle 10, the trailbraking controller 60 may receive output signals from a steering wheel sensor 62, a lateral acceleration sensor 64, a speed sensor 66 and/or a closing obstacle distance device 70. The trailbraking controller 60 monitors the output signals received from the steering wheel sensor 62, the lateral acceleration sensor 64, the speed sensor 66 and/or the closing obstacle distance device 70. When one or more criterion is surpassed, which may be included in a look-up table 68 located within the trailbraking controller 60, the trailbraking controller 60 implements a brake pressure output signal to a brake controller 74 commensurate with the current operating parameters sensed. For example, the brake controller 74, when triggered, may output a 5.1 MPa brake pressure output signal having a step response for a 2 second duration when the vehicle is traveling at 90 Kph. The brake pressure output signal may be continuous, variable, ramped, decayed, impulsed or stepped depending upon the implemented algorithm within the controller 60. Also, the brake pressure output signal may be updated for changing conditions sensed. While various types of brake pressure output signals may be utilized, the implemented signal will be determined for the particular application in conjunction with the dynamics of the particular vehicle.

In one instance, the algorithm used by the trailbraking controller 60 may monitor the signal received from the sensors 62, 64, 66, 70 and then, based upon look-up table 68 or performance criterion that distinguishes when an emergency avoidance maneuver has been initiated, output the brake pressure output signal. The brake pressure output signal may optionally be received directly at the brakes 76, or by way of the stability control system 78 including other vehicle dynamic control systems. The controller 60 controls ultimately the amount of brake force applied at the brakes 76.

The brake pressure output signal can be optimized for maximum, stable, or recommended distance saved ranges as discussed above. Moreover, the brake pressure output signal can be optimized for vehicle stability within the ranges as discussed above.

The brake controller 74 receives the brake pressure output signal coming from the trailbraking controller 60. The brake controller 74 (or the trailbraking controller when directly implemented) will then implement the signal supplying the requested brake pressure at each of the brakes 76. While the brakes 76 have been represented as a single block, it is recognized that there are typically four brakes, each located at the front and back, and left and right side wheels. It is anticipated that the brakes located at all the wheels may receive a proportional amount of brake pressure. Alternately, it is recognized that different brake pressure may be received at each wheel for a particular application. Also, the brake pressure may vary from front wheels to back wheels, or from left side wheels to right side wheels in order to improve the implementation of trailbraking.

The steering wheel sensor 62 provides the rate of change of steering angle resulting by the actions of an operator of the vehicle 10. The steering wheel sensor 62 outputs an analog or digital rate of change signal to the trailbraking controller 60 indicative of the operator's changing actions. The steering wheel signal may be conditionally monitored by the trailbraking controller 60 and may be used to determine when to trigger the controller for outputting a brake pressure output signal. The steering wheel sensor 62 may be one of a variety of angular rate sensors known to those skilled in the art.

The lateral acceleration sensor 64 provides an output signal indicative of changes in lateral acceleration of the vehicle caused by the operator of the vehicle 10. The lateral acceleration signal may be conditionally monitored by the trailbraking controller 60 and may be used to determine when to trigger the controller for outputting a brake pressure output signal. The lateral acceleration sensor 64 may be one of a variety of acceleration sensors known to those skilled in the art.

The speed sensor 66 provides an output signal indicative of the vehicles 10 speed. The speed signal may be conditionally monitored by the trailbraking controller 60 and may be used by the controller for outputting a brake pressure output signal. The speed sensor 66 may be one of a variety of speed sensors known to those skilled in the art.

The collision mitigation system or closing obstacle distance device 70 may provide an output signal indicative of changes in closing obstacle distance between the vehicle 10 and a target vehicle. The closing obstacle distance signal may be conditionally monitored by the trailbraking controller 60 and may be used to determine when to trigger the controller for outputting a brake pressure output signal. The closing obstacle distance device 70 may be one of a variety of distance sensors or change of distance sensors known to those skilled in the art, including radar based devices. Optionally, the closing obstacle distance device 70 may utilize information transmitted from a GPS or navigational system 72 in order to determine the distance of a fast closing vehicle.

It is also anticipated that the trailbraking controller 60 may utilize any combination of steering wheel sensor 62, the lateral acceleration sensor 64 and/or the closing obstacle distance device 70 together with the speed sensor 66 in order to determine when an emergency avoidance maneuver has been initiated.

While specific attention has not been given to the form of any input or output signal, it is recognized that the signals may be any combination of analog or digital signals communicated by way of or by any combination of electrical circuits, over wires, wirelessly, mechanically, electromechanically, hydraulically and electrohydraulically, or by any other communicating device recognized by a person having skill in the art signal transmission.

Also, it is recognized that the devices described above for the present invention may be powered by the vehicle or host system in which the devices resides. Moreover, all of the controllers mentioned in the present invention may be implemented by any kind of controller, including mechanical controllers, however, it is anticipated the controllers will be implemented in the form of a computer processor that includes at least a power source, a processor, an input channel, an output channel, and a memory suitable for implementation for the particular environment as would also be recognized by a person of skill in the art.

From the foregoing, it can be seen that there has been brought to the art a new and improved trailbraking system. While the invention has been described in connection with one or more embodiments, it should be understood that the invention is not limited to those embodiments. On the contrary, the invention covers all alternatives, modifications, and equivalents as may be included within the spirit and scope of the appended claims.

What is claimed is:

1. A trailbraking control system for a vehicle comprising:
a velocity sensor for providing a velocity output signal;
a second sensor for providing a second output signal; and
a trailbraking controller for receiving said velocity output signal and said second output signal,
wherein said trailbraking controller will provide an output control signal conditioned by said velocity output signal and said second output signal when indicative of an emergency avoidance maneuver.

2. The trailbraking control system as recited in claim 1 further comprising at least one brake for receiving said output control signal.

3. The trailbraking control system as recited in claim 2 wherein said output control signal is a brake pressure command controlling said at least one brake.

4. The trailbraking control system as recited in claim 2 wherein said at least one brake includes a front left brake, a front right brake, a back left brake and a back right brake for receiving said output control signal.

5. The trailbraking control system as recited in claim 4 wherein said output control signal is distributed proportionally to said front brakes and said back brakes.

6. The trailbraking control system as recited in claim 4 wherein said output control signal is distributed proportionally to said left brakes and said right brakes.

7. The trailbraking control system as recited in claim 4 wherein said output control signal is individually distributed to said brakes.

8. The trailbraking control system as recited in claim 1 wherein said second sensor is one of a steering wheel sensor, a lateral acceleration sensor or a closing obstacle distance device.

9. The trailbraking control system as recited in claim 1 further comprises a lateral acceleration sensor for providing an acceleration output signal, a closing obstacle distance device for providing a closing obstacle signal and wherein said second sensor is a steering wheel sensor and said second output signal is a steering angle rate signal, wherein said trailbraking controller provides said output control signal conditioned by said velocity output signal and one or more of said acceleration output signal, said closing obstacle signal and said steering angle rate signal when indicative of an emergency avoidance maneuver.

10. The trailbraking control system as recited in claim 9 wherein said trailbraking controller includes a lookup table for providing pressure level of said output control signal determined by said velocity output signal.

11. The trailbraking control system as recited in claim 9 wherein indication of an emergency avoidance maneuver is determined by an acceleration output signal of about 1.5 m/s², a closing obstacle signal of about 47 m at an approach velocity of 100 Kph, or a steering angle rate signal of about 5 rad/s.

12. The trailbraking control system as recited in claim 1 further comprising a brake controller for receiving said output control signal, wherein said brake controller provides at least one brake pressure command signal.

13. The trailbraking control system as recited in claim 1 further comprising a stability control system for receiving said output control signal, wherein said stability control system provides at least one braking command signal.

14. The trailbraking control system as recited in claim 1 wherein said output control signal is a step response having a constant magnitude.

15. The trailbraking control system as recited in claim 1 wherein said output control signal is a step response having a finite duration.

16. The trailbraking control system as recited in claim 15 wherein said finite duration is 2 seconds.

17. The trailbraking control system as recited in claim 1 wherein said output control signal is a ramped or stepped response having a decaying magnitude over a finite duration.

18. The trailbraking control system as recited in claim 1 wherein said output control signal is optimized for various speed ranges and stability parameters for a given vehicle dynamic.

19. A method of operating a trailbraking controller for a vehicle comprising:
monitoring a velocity output signal from a velocity sensor;
monitoring a second output signal from a second sensor; and
determining when an emergency avoidance maneuver is indicated by said second output signal; and
outputting an output control signal conditioned by said velocity output signal and said second output signal when indicative of an emergency avoidance maneuver.

20. The method as recited in claim 19 further comprising determining said output control signal to be outputted for said velocity output signal.

21. A method of operating a trailbraking control system in a vehicle comprising:
providing a brake on at least one wheel of said vehicle;
providing a velocity sensor in said vehicle;
providing at least one of a lateral acceleration sensor, a closing obstacle distance device and a steering wheel sensor in said vehicle; and
providing a trailbraking controller in said vehicle,
said trailbraking controller comprising:
monitoring a velocity output signal from said velocity sensor;
monitoring a second output signal from at least one of said lateral acceleration sensor for providing an acceleration output signal, said closing obstacle distance device for providing a closing obstacle signal and said steering wheel sensor for providing a steering angle rate signal; and
determining when an emergency avoidance maneuver is indicated by said second output signal; and
outputting to said brake an output control signal,
wherein said output control signal is conditioned by said velocity output signal and said second output signal when indicative of an emergency avoidance maneuver.

22. The method as recited in claim 21 wherein said output control signal is a brake hydraulic pressure signal sent directly to said brake.
